(19) United States
(12) Patent Application Publication
(10) Pub. No.: US 2009/0307347 A1
(43) Pub. Date: Dec. 10, 2009

(54) Using Transaction Latency Profiles For Characterizing Application Updates

(76) Inventors: Ludmila Cherkasova, Sunnyvale, CA (US); Ningfang Mi, Williamsburg, VA (US); Mehmet Kivanc Ozonat, Mountain View, CA (US); Julie A. Symons, Santa Clara, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/251,245

(22) Filed: Oct. 14, 2008

Related U.S. Application Data
(60) Provisional application No. 61/048,158, filed on Jun. 8, 2008.

(51) Int. Cl. G06F 15/173

(52) U.S. Cl. 709/224

(57) ABSTRACT

One embodiment is a method that determines transaction latencies occurring at an application server and a database server in a multi-tier architecture. The method then analyzes the transaction latencies at the application server with Central Processing Unit (CPU) utilization during a monitoring window to determine whether a change in transaction performance at the application server results from an update to an application.

### CROSS-REFERENCE TO RELATED APPLICATIONS

This application relates to commonly assigned U.S. patent application having attorney docket number 200704162-1 and entitled “using application performance signatures for characterizing application updates” and incorporated herein by reference.

### BACKGROUND

Application servers area core component of a multi-tier architecture that has become the industry standard for building scalable client-server applications. A client communicates with a service deployed as a multi-tier application through request-reply transactions. A typical server reply consists of the web page dynamically generated by the application server. The application server can issue multiple database calls while preparing the reply. As a result, understanding application level performance is a challenging task.

Significantly shortened time between new software releases and updates makes it difficult to perform a thorough and detailed performance evaluation of an updated application. The problem is how to efficiently diagnose essential performance changes in the application performance and to provide fast feedback to application designers and service providers.

Additionally, an existing production system can experience a very different workload compared to the one that has been used in testing environment. Furthermore, frequent software releases and application updates make it difficult to perform an accurate performance evaluation of an updated application, especially across all the application transactions.

### BRIEF DESCRIPTION OF THE DRAWINGS

FIG. 1 is a multi-tier architecture with a diagnostics tool in accordance with an exemplary embodiment of the present invention.

FIG. 2 is diagram showing transaction latency measured by a diagnostics tool in accordance with an exemplary embodiment of the present invention.

FIG. 3 shows a graph of transaction latencies for two transactions over time in a multi-tier architecture in accordance with an exemplary embodiment of the present invention.

FIG. 4 is a flow diagram for obtaining the transaction latency profile in accordance with an exemplary embodiment of the present invention.

FIG. 5 shows a graph of a home transaction latency profile for three workloads in accordance with an exemplary embodiment of the present invention.

FIG. 6 shows a graph of a shopping cart transaction latency profile for three workloads in accordance with an exemplary embodiment of the present invention.

FIG. 7 shows a graph of a home transaction latency profile for three workloads with outliers removed in accordance with an exemplary embodiment of the present invention.

FIG. 8 shows a graph of a shopping cart transaction latency profile for three workloads with outliers removed in accordance with an exemplary embodiment of the present invention.

FIG. 9 is a flow diagram for comparing transaction latency profiles before and after an application update in accordance with an exemplary embodiment of the present invention.

FIG. 10 shows a graph of an original transaction latency profile plotted against the transaction latency profile after an application is updated in accordance with an exemplary embodiment of the present invention.

FIG. 11 is an exemplary computer system in accordance with an exemplary embodiment of the present invention.

### DETAILED DESCRIPTION

Exemplary embodiments in accordance with the present invention are directed to systems and methods for building transaction latency profiles to characterize application performance in a multi-tier architecture.

Transaction latency profiles are a representative performance model of a transaction that reflects application performance characteristics. Such transaction latency profiles are representative under different workload characteristics. For example, when a software update to an application server occurs, then the transaction latency profiles detect a change in transaction execution time and provide detailed information on this change. Designers can identify whether changes in execution time are caused from updates in the application or changes in workload. In other words, designers can determine whether an increase in transaction latency is the result of a higher load in the system or an application modification that is directly related to increased processing time for a specific transaction type.

One embodiment provides a thorough and detailed performance evaluation of an updated application after a new software release or update is implemented in the system. Exemplary embodiments diagnose changes in the application performance after the update and provide fast feedback to application designers and service providers. Transaction latencies caused by updates or changes in the software are detected and used to evaluate performance of the updated application.

One embodiment is an automated monitoring tool that tracks transaction activity and breaks down transaction latencies across different components and tiers in multi-tiered systems. By way of example, automated tools in accordance with exemplary embodiments divide latency into server-side latency and database-side latency. Analysis of this latency is useful in performance evaluation, debugging, and capacity planning, to name a few examples.

Exemplary embodiments are described in the context of multi-tier architectures for developing scalable client-server applications. Exemplary embodiments design effective and accurate performance models that predict behavior of multi-tier applications when they are placed in an enterprise production environment and operate under real workload mix.

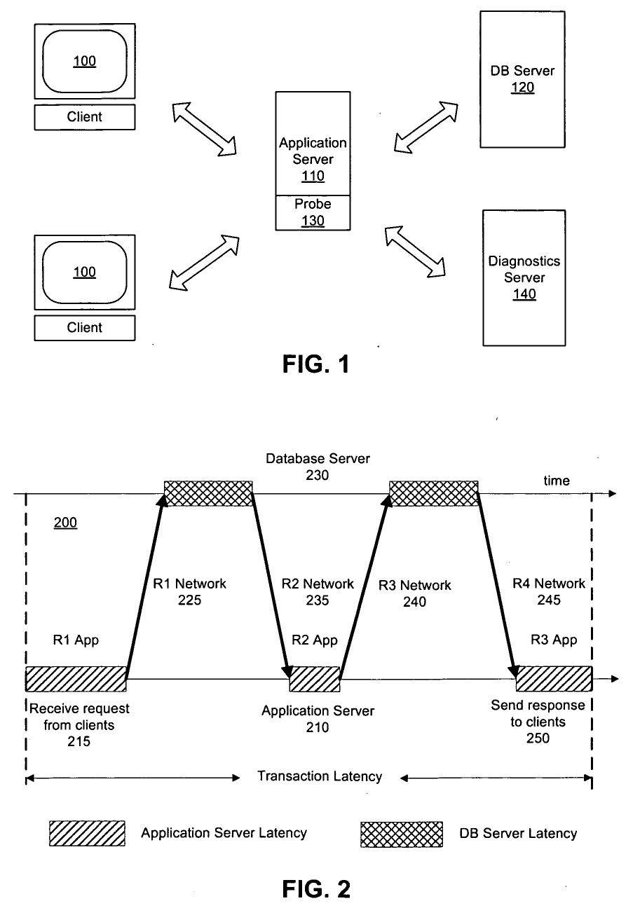

FIG. 1 is a multi-tier architecture with a diagnostics tool in accordance with an exemplary embodiment of the present invention. For discussion purposes, exemplary embodiments are described in the context of a multi-tier e-commerce website that simulates the operation of an on-line retail site, such as a bookstore. A three-tier architecture is shown wherein client computers or users navigate to an internet website and make transaction requests to one or more application servers and databases.

In a three-tier architecture for an application, the application comprises the following three tiers: (1) an interface tier (sometimes referred to as the web server or the presentation tier), (2) an application tier (sometimes referred to as the logic or business logic tier), and (3) a data tier (e.g., database tier). There are also plural client computers 100 that communicate with the multiple tiers and provide a user interface, such as a graphical user interface (GUI), with which the user interacts with the other tiers. The second tier is shown as an application server 110 that provides functional process logic. The application tier can, in some implementations, be multi-tiered itself (in which case the overall architecture is called an “n-tier architecture”). For example, the web server tier (first tier) can reside on the same hardware as the application tier (second tier). The third tier is shown as a database server 120 and manages the storage and access of data for the application. In one embodiment, a relational database management system (RDBMS) on a database server or mainframe contains the data storage logic of the third tier.

In one embodiment, the three tiers are developed and maintained as independent modules (for example, on separate platforms). Further, the first and second tiers can be implemented on common hardware (i.e., on a common platform), while the third tier is implemented on a separate platform. Any arrangement of the three tiers (i.e., either on common hardware or across separate hardware) can be employed in a given implementation. Furthermore, the three-tier architecture is generally intended to allow any of the three tiers to be upgraded or replaced independently as requirements, desires, and/or technology change.

One embodiment extracts logs with a diagnostic tool. This diagnostic tool collects data from the instrumentation with low overheads and minimum disruption to the transaction. By way of example, the tool provides solutions for various applications, such as J2EE applications, .NET applications, ERP/CRM systems, etc.

In one embodiment, the diagnostics tool consists of two components: a diagnostics probe 130 in the application server 110 and a diagnostics server 140. The diagnostics tool collects performance and diagnostic data from applications without the need for application source code modification or recompilation. It uses byte code instrumentation and industry standards for collecting system and Java Management Extensions (JMX) metrics. Instrumentation refers to byte code that the diagnostic probe inserts into the class files of application as the applications are loaded by the class loader of a virtual machine. Instrumentation enables the probe 130 to measure execution time, count invocations, retrieve arguments, catch exceptions and correlate method calls and threads.

The diagnostic probe 130 is responsible for capturing events from the application, aggregating the performance metrics, and sending these captured performance metrics to the diagnostics server 140. In a monitoring window, the diagnostics tool provides one or more of the following information for each transaction type:
(1) A transaction count.
(2) An average overall transaction latency for observed transactions. The overall latency includes transaction processing time at the application server 110 as well as all related query processing at the database server 120, i.e., the latency is measured from the moment of the request arrival at the application server to the time when a prepared reply is sent back by the application server 110 (see FIG. 2).
(3) A count of outbound (database) calls of different types.
(4) An average latency of observed outbound calls (of different types). The average latency of an outbound call is measured from the moment the database request is issued by the application server 110 to the time when a prepared reply is returned back to the application server, i.e., the average latency of the outbound call includes database processing and the communication latency.

One exemplary embodiment implements a Java-based processing utility for extracting performance data from the diagnostics server 140 in real-time. This utility creates an application log that provides complete information on all the transactions processed during the monitoring window, their overall latencies, outbound calls, and the latencies of the outbound calls.

Assuming that there are totally M transaction types processed by the application server 110, the following notations are used:
(1) T=1 min is the length of the monitoring window;
(2) Nᵢ is the number of transactions Trᵢ, i.e., i-th type, where 1≦i≦M;
(3) Rᵢ is the average latency of transaction Trᵢ;
(4) Pᵢ is the total number of types of outbound DB calls for transaction Trᵢ;
(5) N_{i,j}^{DB} is the number of DB calls for each type j of outbound DB call for transaction Trᵢ, where 1≦j≦Pᵢ;
(6) R_{i,j}^{DB} is the average latency for each type j of outbound DB call, where 1≦j≦Pᵢ;
(7) U_{CPU,n} is the average CPU utilization at the n-tier during this monitoring window (e.g., n=2 for TPC-W).

The specific types of different transactions vary according to the system. For a retail website, such transactions types include, but are not limited, client requests during browsing, clicking on a hyperlink, adding items to a shopping cart, retrieving detailed information on a particular product, checking out after selecting items to purchase, etc.

Table 1 shows a fragment of the extracted application log for a 1-minute time monitoring window.

TABLE 1

| time | N₁ R₁ | . . . | N_{M} R_{M} | N_{1,1}^{DB} R_{1,1}^{DB} | . . . | N_{1,Pi}^{DB} R_{1,Pi}^{DB} | . . . | U_{CPU} |
|---|---|---|---|---|---|---|---|---|
| 1 min | 28, 4429.5 | . . . | 98, 1122.9 | 56, 1189.7 | . . . | 28, 1732.2 | . . . | 8.3% |
| 2 min | | . . . | . . . , . . . | | . . . | . . . , . . . | . . . | . . . |

If the solution has multiple application servers in the configuration then there are multiple diagnostics probes installed at each application server. Further in one embodiment, each probe independently collects data at these application servers supported by, for example, heterogeneous machines with different CPU speeds. Data processing is done for each probe separately.

FIG. 2 is diagram 200 showing transaction latency measured by the diagnostics tool in accordance with an exemplary embodiment of the present invention. The application server 210 receives a request from clients 215. This request (R1 App) is routed over a network (R1 network 225) to the database server 230. The database server processes the request and transmits a response (R2 network 235) over the network and back to the application server 210. Here, the application server processes the response and transmits a request (R3 network 240) back to the database server 230 for processing. In turn, the database server 230 transmits the response (R4 network 245) over the network to the application server 210. This response is sent to the client 250.

As shown in FIG. 2, transaction latencies accumulate at various stages between the time the request is received and the time the response is provided to the client. The overall latency includes transaction processing time at the application server 110 (FIG. 1) as well as all related query processing at the database server 120 (FIG. 1). In one embodiment, the latency is measured from the moment of the request arrival at the application server 215 to the time when a prepared reply is sent back to the clients 250.

While it is useful to have information about current transaction latencies that implicitly reflect the application and system health, such information provides limited insight into the causes of the observed latencies and cannot be used directly to detect the performance changes of an updated or modified application introduced into the system.

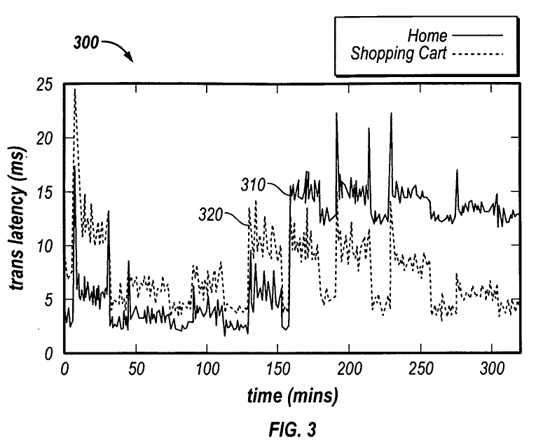

FIG. 3 shows a graph 300 of transaction latencies for two transactions over time in a multi-tier architecture in accordance with an exemplary embodiment of the present invention. Specifically, two transactions “home” 310 and “shopping cart” 320 are shown for about 300 minutes. The latencies of both transactions vary over time and get visibly higher in the second half of the graph 300. This increase in latency, however, does not look suspicious because the increase can be a simple reflection of a higher load in the system (i.e., a greater number of transactions being simultaneously being processed).

After timestamp 160 min, one embodiment began executing an updated version of the application code where the processing time of the home transaction 310 is increased by 10 milliseconds. By examining the measured transaction latency over time, one cannot detect the cause of this increase since the reported latency metric does not provide enough information to detect this change. Exemplary embodiments, however, provide methods for determining the cause of this transaction latency increase shown in graph 300. By using measured transaction latency and its breakdown information, exemplary embodiments process and present the latency to quickly and efficiently diagnose essential performance changes in the application performance and to provide fast feedback to application designers and service providers.

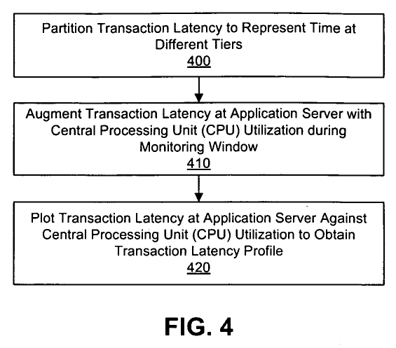

FIG. 4 is a flow diagram for obtaining the transaction latency profile in accordance with an exemplary embodiment. As used herein and in the claims, the term “transaction latency profile” means plotting, measuring, or determining a measured transaction latency of one or more transactions against the system load or CPU utilization in a multi-tier architecture with an application server making requests to a database server.

According to block 400, the transaction latency is partitioned into complimentary portions that represent time spent at different tiers of the multi-tier architecture. For example, the transaction latencies are divided between latencies at the front or application server (i.e., second tier) and the database server (i.e., the third tier).

According to block 410, the transaction latency at the application server is augmented with the Central Processing Unit (CPU) utilization of the application server measured during the same monitoring window.

According to block 420, the transaction latency at the application server is plotted against the CPU utilization. The graph of this plot provides a representative transaction latency profile. This transaction profile is similar under different transaction mixes. In other words, it is uniquely defined by the transaction type and CPU utilization of the server and is practically independent of the transaction mix.

The transaction latency includes both the waiting time and the service times across the different tiers (e.g., the front server and the database server) that a transaction flows through.

For discussion, Rᵢ^{front} and Rᵢ^{DB} are the average latency for the i-th transaction type at the front and database servers respectively. Exemplary embodiments discover Rᵢ^{front} because this value represents the latencies that are occurring as a result of the application (as opposed to latencies occurring at the database server). Although Rᵢ^{front} shows the latency at the application server, this value is not static but depends on current load of the system.

The transaction latency is calculated as follows:

Rᵢ=Rᵢ^{front}+Rᵢ^{DB}=Rᵢ^{front}+(Σⱼ₌₁^{Pi} N_{i,j}^{DB}*R_{i,j}^{DB})/Nᵢ

Using this equation, exemplary embodiments calculate Rᵢ^{front}. Then, for each transaction Trᵢ, exemplary embodiments generate 100 CPU utilization buckets {Uⁱ₁=1, Uᵢ²=2 . . . , Uⁱₖ=k, . . . , Uⁱ₁₀₀=100}.

Using extracted application logs, for each one minute monitoring window, exemplary embodiments classify observed transactions into the corresponding CPU utilization buckets. For example, if during the current monitoring window there are Nᵢ transactions of type i with average latency Rᵢ^{front} under observed CPU utilization of 10% at the application server, then a pair (Nᵢ, Rᵢ^{front}) goes in the CPU utilization bucket Uⁱ₁₀. Finally, for each CPU bucket Uₖ, exemplary embodiments compute average latency R_{i,k}^{front} and overall transaction count N_{i,k}.

For each transaction Trᵢ, exemplary embodiments create a transaction latency profile in the following format: [Uₖ, N_{i,k}, R_{i,k}^{front}]. Here, 1≦i≦M and 1≦k≦100. In each CPU bucket, exemplary embodiments store information on overall transaction count N_{i,k} because this information is used in assessing whether the bucket is representative.

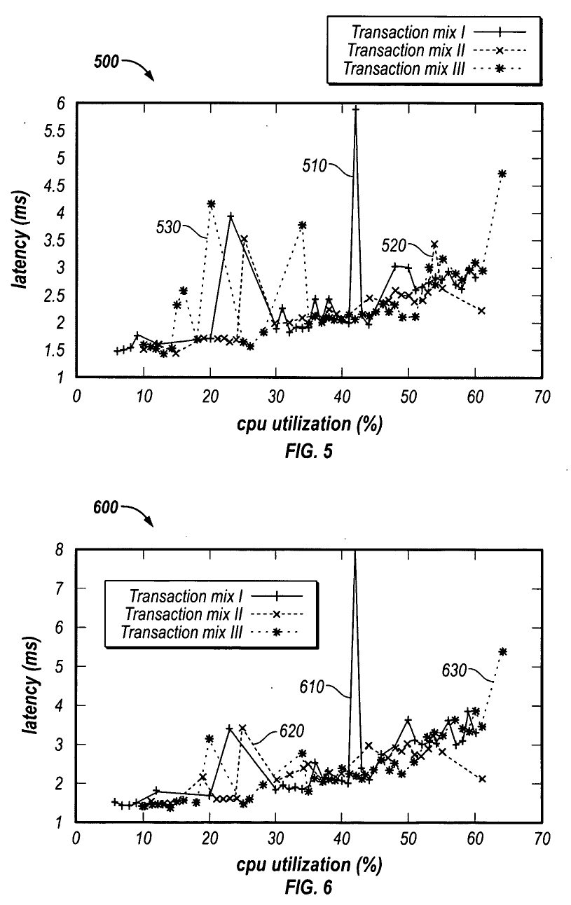

FIGS. 5 and 6 represent examples of latency profiles for “home” and “shopping cart” transactions for the online retail website. In each figure, three curves are used to correspond to three different workloads. Specifically, FIG. 5 shows a transaction latency profile 500 for the home transaction for a first transaction mix 510, a second transaction mix 520, and a third transaction mix 530. FIG. 6 shows a transaction latency profile 600 for the shopping cart transaction for a first transaction mix 610, a second transaction mix 620, and a third transaction mix 630. In FIGS. 5 and 6, the transaction mixes 510 and 610 are equal; transaction mixes 520 and 620 are equal; and transaction mixes 530 and 630 are equal.

As shown in FIGS. 5 and 6, the transaction latency profiles do look similar under different workloads. The existence of outliers in these curves, however, makes the formal comparison a difficult task. An outlier is a deviation (for example, unusual or infrequent events) in samples or portions of the data. Typically, the outliers correspond to some under-represented CPU utilization buckets with few transaction occurrences. As a result, an average transaction latency is not representative for the corresponding CPU utilization bucket. One embodiment creates a more representative latency profile (having less outliers or non-representative buckets) by taking into consideration only the points that constitute 90% of the most populated CPU buckets.

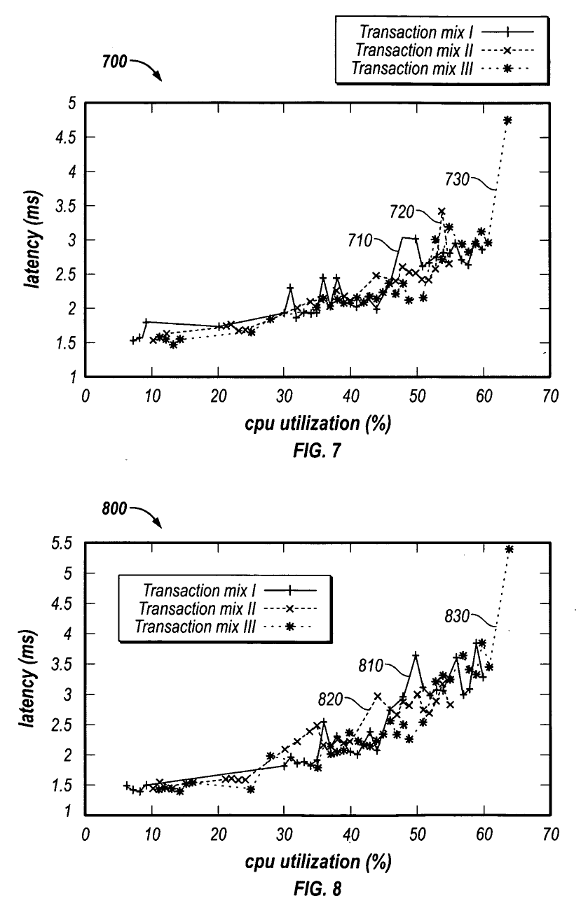

FIG. 7 and FIG. 8 illustrate examples of the transaction latency profiles for home transactions and shopping cart transactions that use only 90% of the most populated CPU buckets. Specifically, FIG. 7 shows a transaction latency profile 700 for home for a first transaction mix 710, a second transaction mix 720, and a third transaction mix 730. FIG. 8 shows a transaction latency profile 800 for shopping cart for a first transaction mix 810, a second transaction mix 820, and a third transaction mix 830. In FIGS. 7 and 8, the transaction mixes 710 and 810 are equal (which are equal to transaction mixes 510 and 610 in FIGS. 5 and 6); transaction mixes 720 and 820 are equal (which are equal to transaction mixes 520 and 620 in FIGS. 5 and 6); and transaction mixes 730 and 830 are equal (which are equal to transaction mixes 530 and 630 in FIGS. 5 and 6).

One embodiment uses transaction latency profile as a compact performance model of a transaction. A transaction latency profile is created before the application update and then after the application update to compare whether there is a significant change in transaction performance. By comparing the transactions that are frequently performed by the users, exemplary embodiments provide performance changes of the application.

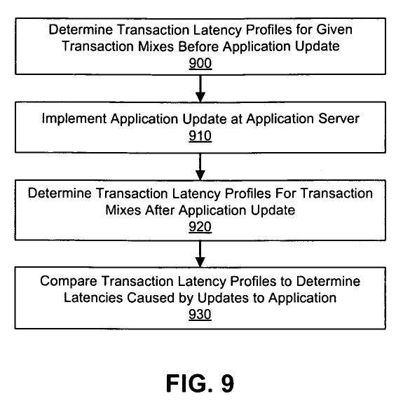

FIG. 9 is a flow diagram for comparing transaction latency profiles before and after an application update in accordance with an exemplary embodiment of the present invention.

According to block 900, transaction latency profiles are performed before the application is updated at the application server. For example, transaction latency profiles (such as those shown in FIGS. 7 and 8) are performed for the home and shopping cart transactions.

According to block 910, the application at the application server is updated or modified.

According to block 920, transaction latency profiles are constructed or calculated after the application is updated at the application server. In other words, after the modified application is installed and executing at the application server, the transaction latency profiles are again constructed or calculated for the same workloads or transaction mixes.

According to block 930, a comparison is performed between the transaction latency profiles before the application is updated and the transaction latency profiles after the application is updated. This comparison reveals the latencies that are caused by the updates to the application (as opposed to latencies caused by a change in load).

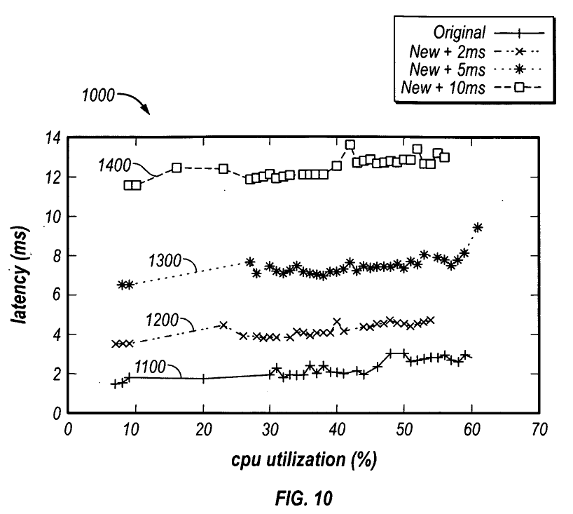

In order to see whether a transaction latency profile can reflect the application change, one embodiment modified the source code of the home transaction. Specifically, the transaction execution time was increased by inserting a controlled CPU-hungry loop into the code of this transaction. Next, the embodiment performed three additional experiments with differently modified versions, where the service time of the home transaction (the 8th transaction) is increased by i) 2 milliseconds, ii) 5 milliseconds, and iii) 10 milliseconds, respectively. The transaction latency profiles of the modified applications are shown in FIG. 10 as a graph 1000. Here, the original transaction latency profile 1100 is plotted as the base line against transaction latency profile 1200 (with an increase by 2 milliseconds), transaction latency profile 1300 (with an increase by 5 milliseconds), and transaction latency profile 1400 (with an increase by 10 milliseconds).

Indeed, comparing a new transaction latency profile against the original profile allows detection of the application performance changes related to the home transaction. The transaction latency profile enables a quick check of the possible performance changes in the application behavior between updates while the application continues its execution in the production environment. By way of example, the transaction latency profiles can be output to a computer display, provided to a computer for storing or processing, provided to a user, etc.

One embodiment computes Pᵢ, the total number of types of outbound DB calls for transaction Trᵢ. These numbers are used to compare the possible transaction code modification with respect to a number of different calls a transaction can issue and report when the number of types of outbound DB calls is changed between the updates.

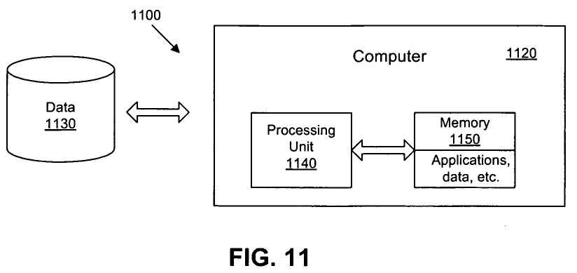

Embodiments in accordance with the present invention are utilized in or include a variety of systems, methods, and apparatus. FIG. 11 illustrates an exemplary embodiment as a computer system 1100 for being or utilizing one or more of the computers, methods, flow diagrams and/or aspects of exemplary embodiments in accordance with the present invention.

The system 1100 includes a computer system 1120 (such as a host or client computer) and a repository, warehouse, or database 1130. The computer system 1120 comprises a processing unit 1140 (such as one or more processors of central processing units, CPUs) for controlling the overall operation of memory 1150 (such as random access memory (RAM) for temporary data storage and read only memory (ROM) for permanent data storage). The memory 1150, for example, stores applications, data, control programs, algorithms (including diagrams and methods discussed herein), and other data associated with the computer system 1120. The processing unit 1140 communicates with memory 1150 and data base 1130 and many other components via buses, networks, etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

In one exemplary embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
measuring first transaction latencies occurring at an application server that issues requests received from a client computer for transactions to a database server;
measuring second transaction latencies occurring at the application server after providing an update to an application executing at the application server;
comparing the first and second transaction latencies to determine whether a change in transaction performance at the application server results from the update; and
providing results of the change to a user.

2) The method of claim 1 further comprising, simultaneously plotting the first and second transaction latencies on a graph to show whether the change in transaction performance at the application server results from the update.

3) The method of claim 1 further comprising, plotting the first and second transaction latencies against Central Processing Unit (CPU) utilization.

4) The method of claim 1 further comprising, measuring transaction latencies for waiting times and service times at both the application server and the database server.

5) The method of claim 1 further comprising, calculating an average latency for different types of transactions at both the application server and the database server.

6) The method of claim 1 further comprising, classifying observed transactions at the application server into Central Processing Unit (CPU) buckets for each of plural different monitoring windows of time.

7) The method of claim 1 further comprising, calculating an average latency and an overall transaction count at different levels of processing utilization.

8) A tangible computer readable storage medium having instructions for causing a computer to execute a method, comprising:
determining transaction latencies occurring at an application server and a database server in a multi-tier architecture;
analyzing the transaction latencies at the application server with Central Processing Unit (CPU) utilization during a monitoring window to determine whether a change in transaction performance at the application server results from a modification to an application; and
outputting analysis of the change.

9) The tangible computer readable storage medium of claim 8 further comprising, plotting the transaction latencies at the application server against the CPU utilization to produce a transaction latency profile.

10) The tangible computer readable storage medium of claim 8 further comprising, removing outliers from the transaction latencies at the application server to remove CPU utilization that is under-represented.

11) The tangible computer readable storage medium of claim 8 further comprising, simultaneously comparing on a graph transaction latency profiles observed before the modification to transaction latency profiles occurring after the modification.

12) The tangible computer readable storage medium of claim 8 further comprising, computing a total number of types of outbound database calls from the application server to the database server for different types of transactions.

13) The tangible computer readable storage medium of claim 8 further comprising, plotting the transaction latencies occurring at the application server against the CPU utilization for plural different workload mixes.

14) The tangible computer readable storage medium of claim 8 further comprising, determining whether a change in transaction execution time at the application server results from an increase in workload or the modification.

15) The tangible computer readable storage medium of claim 8 further comprising, determining whether an increase in processing time at the application server is from an increase in load in the multi-tier architecture or the modification.

16) A computer system, comprising:
a memory for storing an algorithm; and
a processor for executing the algorithm to:
determine transaction latencies occurring at an application server and a database server in a multi-tier architecture; and
analyze the transaction latencies at the application server with Central Processing Unit (CPU) utilization during a monitoring window to determine whether a change in transaction performance at the application server results from an update to an application.

17) The computer system of claim 16, wherein the processor further executes the algorithm to plot the transaction latencies of the application server to visually show whether the change in the transaction performance results from the update to the application or changes in transaction workload occurring at the application server.

18) The computer system of claim 16, wherein the processor further executes the algorithm to plot the transaction latencies at the application server against the CPU utilization to produce a transaction latency profile.

19) The computer system of claim 16, wherein the processor further executes the algorithm to remove outliers from the transaction latencies at the application server to remove CPU utilization that is under-represented.

20) The computer system of claim 16, wherein the processor further executes the algorithm to determine whether the change in transaction performance results from an increase in load in the multi-tier architecture.
